(19) United States
(12) Patent Application Publication
(10) Pub. No.: US 2012/0066121 A1
(43) Pub. Date: Mar. 15, 2012

(54) Brokered Bill Payment

(75) Inventors: Hamed Shahbazi, Vancouver (CA); Frank Lyons, New Westminster (CA); Laurent May, West Vancouver (CA)

(73) Assignee: TIO NETWORKS CORPORATION, Vancouver (CA)

(21) Appl. No.: 13/233,513

(22) Filed: Sep. 15, 2011

Related U.S. Application Data
(60) Provisional application No. 61/383,097, filed on Sep. 15, 2010.

(51) Int. Cl. G06Q 20/40

(52) U.S. Cl. 705/40

(57) ABSTRACT

A Requestor receives a bill from a Payee requesting payment for goods and/or services. If the Requestor wishes to solicit assistance in making a desired payment to the payee (e.g., if the Requestor has insufficient funds available to make the desired payment), the requestor directly or indirectly solicits assistance from contacts available to the requestor. Assuming that one or more of the Requestor's contacts agrees to assist in making the desired payment to the payee, each Payor sends a payment to the Intermediary to be handled in trust on behalf of the Requestor. The Intermediary sends each payor's contribution to the Payee on behalf of the Requestor.

### CROSS-REFERENCE TO RELATED APPLICATIONS

The present application claims benefit of priority to U.S. Provisional Patent Application No. 61/383,097, entitled “Pay My Bills,” and filed on Sep. 15, 2010, which is specifically incorporated by reference herein for all it discloses or teaches.

### BACKGROUND

Modern economics systems utilize one or more currencies as a medium of exchange for goods and/or services. A first party may pay a second party a quantity of a currency (or funds) in exchange for specific goods and/or services that the second party supplies to the first party. However, the first party may not have sufficient funds available to pay the second party and may ask one or more third parties to help the first party cover the amount of funds required to receive the specific goods and/or services from the second party. More specifically, the first party may have an outstanding monetary obligation owed to the second party and may ask one or more third parties to help cover the outstanding monetary obligation. The first party and one or more third parties combine resources to satisfy the outstanding monetary obligation.

For example, a Requestor owes a sum of money to a power company (Payee) for supplying power to the individual's home. The Requestor only has a faction of the owed sum of money, but wants to pay the entire sum of money to the Payee to prevent the Payee from disconnecting power to the Requestor. The Requestor may ask friends and/or family (potential Payors) to contribute money help the Requestor pay the outstanding monetary obligation. Hopefully, the Requestor collects sufficient money from the Payors to pay the entire sum of money to the Payee and prevent the Payee from disconnecting power to the Requestor.

A problem with this is that the Payors contribute money directly to the Requestor and have no guarantee that the Requestor will use the contributed money to actually satisfy the obligation. For example, an alcoholic or compulsive gambler may spend the money on alcohol or gambling instead of satisfying the outstanding monetary obligation. This risk may decrease number of Payors willing to contribute and/or the amount each willing Payor contributes to help satisfy the Requestor's monetary obligation.

### SUMMARY

The presently disclosed technology allows multiple Payors to satisfy a monetary obligation via an Intermediary. For example, the Intermediary receives a payment request from a Requestor, forwards the request to a group of potential Payors, receives a payment or payment authorization from one or more Payors; and forwards the payment or payment authorization to a Payee on behalf of the Requestor to satisfy a financial obligation of the Requestor.

Other implementations are also described and recited herein.

### BRIEF DESCRIPTIONS OF THE DRAWINGS

FIG. 1 is an example system diagram for requesting and directing a payment to satisfy a requestor's monetary obligation.

FIG. 2 is an example system diagram for authorizing, requesting, and directing a payment to satisfy a requestor's monetary obligation.

FIG. 3 is an example system diagram for authorizing, requesting, and directing multiple payments to satisfy a monetary obligation of multiple payors.

FIG. 4 illustrates example operations for requesting and directing a payment to satisfy a requestor's monetary obligation.

FIG. 5 illustrates example operations for authorizing, requesting, and directing a payment to satisfy a requestor's monetary obligation.

FIG. 6 illustrates example operations for authorizing and directing multiple payments to satisfy a monetary obligation of multiple payors.

FIG. 7 illustrates an example computing system that can be used to implement the presently disclosed technology

### DETAILED DESCRIPTIONS

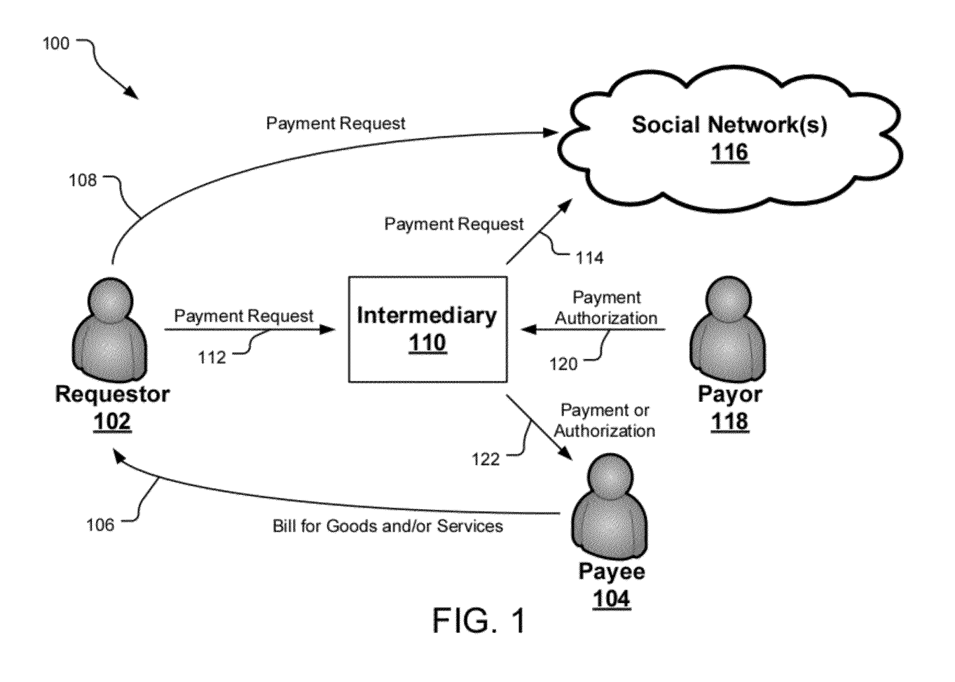

FIG. 1 is an example system diagram 100 for requesting and directing a payment to satisfy a Requestor's monetary obligation. A Requestor 102 (or requesting party) receives a bill from a Payee 104 requesting payment for goods and/or services (G&S) (see arrow 106). Each of the Requestor 102 and the Payee 104 may be an individual party, group of individuals, or a business entity. Further, the bill may come in any communication form (e.g., verbal or written) and be transmitted via any communication medium (e.g., verbal conversation, hand delivered or mailed written correspondence, electronic mail, SMTP (simple mail transfer protocol) message, social networking correspondence, facsimile, etc.). The bill may be for G&S already rendered or delivered to the Requestor 102 or other third party or for G&S that will be delivered to the Requestor 102 or other third party upon receipt of the payment. In other implementations, the bill is in the form of a solicitation for a gift, charitable donation, political contribution, friends-and-family startup funding, or payment for specific G&S.

In other implementations, there is no bill received from the Payee 104. For example, the Requestor 102 may wish to send an unsolicited payment to the Payee 104 along with a request for specific G&S in exchange for the payment. In another example implementation, the Requestor 102 wishes to make an unsolicited gift or donation to the Payee 104 with no expectation of a direct exchange for the payment.

If the Requestor 102 wishes to solicit assistance in making a desired payment to the Payee 104 (e.g., if the Requestor 102 has insufficient funds available to make the desired payment), the Requestor 102 directly or indirectly solicits assistance from contacts available to the Requestor 102. In one implementation, the Requestor 102 posts a message via a social networking medium 116 (e.g., Twitter©, Linkedln©, or Facebook©) requesting assistance from contacts connected to the Requestor 102 via the social networking medium 116 in making the desired payment (see arrow 108). In another implementation, the Requestor 102 sends an Intermediary 110 a payment request (see arrow 112). The Intermediary 110 posts the payment request on one or more social networking media 116 associated with the Requestor 102 requesting assistance from contacts connected to the Requestor 102 via the social networking medium 116 (see arrow 114). In other implementations, the Requestor 102 directly solicits assistance from contacts available to the Requestor 102 via any available medium (e.g., telephone, mail, e-mail, SMTP message). In yet other implementations, the Intermediary 110 directly solicits assistance from contacts available to the Requestor 102 via any available medium (e.g., telephone, mail, e-mail, SMTP message).

Assuming that one or more of the Requestor's contacts agrees to assist in making the desired payment to the Payee 104 (e.g., Payor 118), each Payor sends a payment to the Intermediary 110 to be handled in trust on behalf of the Requestor 102 (see Payment Authorization arrow 120). In other implementations, each Payor sends an authorization to the Intermediary 110 to access an external account. The Intermediary 110 sends each Payor's contribution (or access to each Payor's external account for each Payor's contribution) to the Payee 104 on behalf of the Requestor 102. The sent payment partially or fully satisfies the Requestor's desired payment to the Payee 104. For example, each individual Payor may only agree to contribute a fraction of the entire amount requested by Requestor 102. The Intermediary 110 may compile the contributed amounts and make a sum payment to the Payee 104.

In another example implementation, the Requestor 102 wishes to solicit assistance to pay for aspects of a large event (e.g., a wedding, honeymoon, or child birth). The Requestor 102 solicits assistance from contacts available to the Requestor 102 to pay for specific components of the event (e.g., drinks at a wedding) or the event generally. One or more Payors make payment through the Intermediary 110 to cover a portion of the specific event component or the event generally.

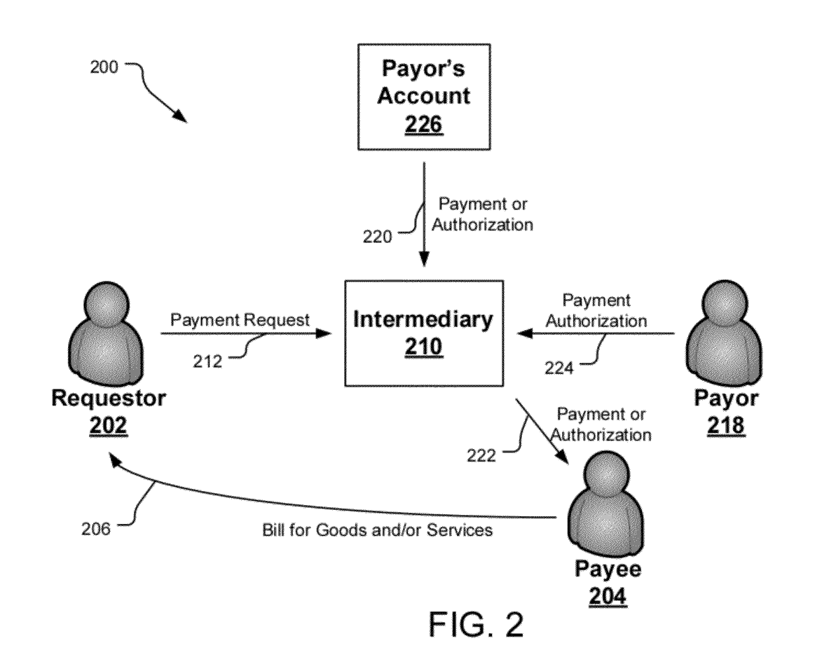

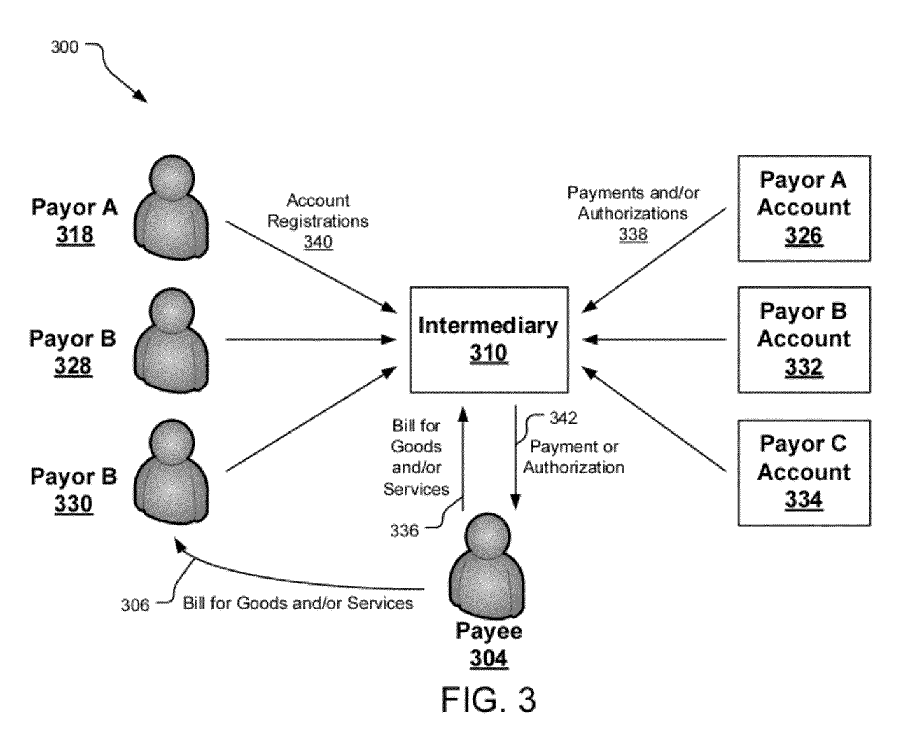

The Intermediary 110 receives data from the Requestor 102, Payor 118, Payee 104, and/or social network 116 via a receiving module. The Intermediary 110 sends data to the Requestor 102, Payor 118, Payee 104, and/or social network 116 via a sending module. Further, the system diagram 100 may be combined with aspects of one or both of system diagrams 200, 300 of FIGS. 2 and 3 to yield additional options for satisfying financial obligations.

FIG. 2 is an example system diagram 200 for authorizing, requesting, and directing a payment to satisfy a Requestor's monetary obligation. A Payor 218 registers with an Intermediary 210 and authorizes the Intermediary 210 to make payment for certain G&S on behalf of a Requestor 202 (see arrow 224). The authorization may include a variety of restrictions (e.g., only specific G&S providers, a maximum individual transaction amount, a maximum total transaction amount within a fixed time period, an approved geographical region from which charges may be made, etc.) on payment requests. Further, the authorization may include a variety of notices to the Payor 218 ranging from notifying the Payor 218 of all transactions conducted on behalf of the Requestor 202 in real-time to notifying the Payor 218 when a individual or cumulative transaction amount exceeds a threshold or when charges are made outside of a specified geographic region.

The authorization includes conditional access to the payor's account 226, which may be internal to the intermediary 210 or an external account. The Intermediary 210 may use the Payor's account 226 to make payments to the Payee 204 subject to the payor's conditions and restrictions on use of the payor's account 226. The payor's account 226 may be a stored value or credit account with the Intermediary 210 or a stored value or credit account with a separate entity and linked to the Intermediary 210.

A Requestor 202 receives a bill from a Payee 204 requesting payment for G&S (see arrow 206). Each of the Requestor 202 and Payee 204 may be an individual party, group of individuals, or a business entity. Further, the bill may come in any communication form (e.g., verbal or written) and be transmitted via any communication medium (e.g., verbal conversation, hand delivered or mailed written correspondence, electronic mail, SMTP (simple mail transfer protocol) message, social networking correspondence, facsimile, etc.). The bill may be for G&S already rendered or delivered to the Requestor 202 or other third party or for G&S that will be delivered to the Requestor 202 or other third party upon receipt of the payment. In other implementations, the bill is in the form of a solicitation for a gift, donation, or payment for specific G&S.

In other implementations, there is no bill received from the Payee 204. For example, the Requestor 202 may wish to send an unsolicited payment to the Payee 204 along with a request for specific G&S in exchange for the payment. In another example implementation, the Requestor 202 wishes to make an unsolicited gift or donation to the Payee 204 with no expectation of a direct exchange for the payment.

If the Requestor 202 desires to make a payment from the payor's account 226, the Requestor 202 submits a payment request to the Intermediary 210 (see arrow 212). The Intermediary 210 evaluates the payment request and determines whether the payment request satisfies the restrictions on use of the payor's account 226 specified by the Payor 218. If the payment request satisfies the payor's restrictions, the Intermediary 210 withdraws the requested payment from the payor's account 226 (see arrow 220) and sends the payment to the Payee 204 (see arrow 222). In other implementations, the Intermediary 210 sends a payment authorization to the Payee 204 to charge the requested amount to the Payor's Account 226 without handling the payment itself.

The Intermediary 210 receives data from the Requestor 202, Payor 218, Payee 204, and/or Payor's account 226 via a receiving module. The Intermediary 210 sends data to the Requestor 202, Payor 218, Payee 204, and/or Payor's account 226 via a sending module. Further, the system diagram 200 may be combined with aspects of one or both of system diagrams 100, 300 of FIGS. 1 and 3 to yield additional options for satisfying financial obligations.

FIG. 3 is an example system diagram 300 for authorizing, requesting, and directing multiple payments to satisfy a monetary obligation of multiple payors. Multiple payors (e.g., Payors 318, 328, 330) may be jointly responsible for payment of a financial obligation. For example, the Payors 318, 328, 330 may be roommates and jointly responsible for rent, power/gas bills, cable television bills, internet bills, phone bills, water bills, etc.

The Payors 318, 328, 330 receive a bill from a Payee 304 requesting payment for G&S (see arrow 306). Each of the Payors 318, 328, 330 and the Payee 304 may be an individual party, group of individuals, or a business entity. Further, the bill may come in any communication form (e.g., verbal or written) and be transmitted via any communication medium (e.g., verbal conversation, hand delivered or mailed written correspondence, electronic mail, SMTP (simple mail transfer protocol) message, social networking correspondence, facsimile, etc.). The bill may be for G&S already rendered or delivered to the Payors 318, 328, 330 or other third party or for G&S that will be delivered to the Payors 318, 328, 330 or other third party upon receipt of the payment. In other implementations, the bill is in the form of a solicitation for a gift, donation, or payment for specific G&S.

In other implementations, there is no bill received from the Payee 304. For example, the Payors 318, 328, 330 may wish to send an unsolicited payment to the Payee 304 along with a request for specific G&S in exchange for the payment. In another example implementation, the Payors 318, 328, 330 wish to make an unsolicited gift or donation to the Payee 304 with no expectation of a direct exchange for the payment.

Each of the Payors 318, 328, 330 desire that the bills for which they are jointly responsible be paid in full so that the purchased G&S are not disconnected or discontinued. However, each of the Payors 318, 328, 330 only wish to pay their corresponding portion of the outstanding bills. As a result, each of the Payors 318, 328, 330 register an account (i.e., Payor A Account 326, Payor B Account 332, and Payor C Account 334) with the Intermediary 310 (see arrows 340). Further, the Payee 304 may send the payors' bill to the Intermediary 310 (see arrow 336). In another implementation, one or more of the Payors 318, 328, 330 sends the payors' bill to the Intermediary 310.

When paying the bill, the Intermediary 310 attempts to withdraw an amount from each of the payors' accounts corresponding to each payor's expected contribution to paying the bill (see arrow 338). Each of the payor's accounts may be internal to the Intermediary 310 or external. The Intermediary 310 then forwards the cumulative payment (or individual payments) or cumulative authorization (or individual authorizations) to the Payee 304 to pay the bill in full (see arrow 342). If one or more of the payors' accounts 326, 332, 334 have insufficient funds or the Intermediary 310 is unable to access one or more of the payors' accounts 326, 332, 334, the Intermediary 310 will attempt to satisfy as much of the expected contribution as possible from the payor account(s) with insufficient funds and withdraw an additional amount from the other payors' accounts in order to pay the entire bill to the Payee 304.

Further, if the Intermediary 310 withdraws an amount from an individual payor's account greater than that individual payor's contribution, the individual payor may be notified and in some implementations given the option to refuse to pay the additional amount to pay the entire bill. Still further, any overpayments by one or more of the Payors 318, 328, 330 may be tracked over time by the Intermediary 310. In one implementation, the Intermediary 310 may attempt to remedy overpayment on one bill by one or more payors by overcharging the underpaying payors and undercharging the overpaying payors on subsequent bills. Still further, the Intermediary 310 may periodically remind underpaying payors that they owe a financial obligation to the overpaying payors. If one or more of the payors' accounts has insufficient funds but the Intermediary 310 is unaware of the total amount available (e.g., if the payor accounts are external credit or debit accounts), the Intermediary 310 may make repeated attempts to withdraw sequentially smaller amounts from the payors' accounts until the payment request is approved.

The Intermediary 310 receives data from the Payors 318, 328, 330, Payor accounts 326, 332, 334, and/or Payee 304 via a receiving module. The Intermediary 310 sends data to the Payors 318, 328, 330, Payor accounts 326, 332, 334, and/or Payee 304 via a sending module. Further, the system diagram 300 may be combined with aspects of one or both of system diagrams 100, 200 of FIGS. 1 and 2 to yield additional options for satisfying financial obligations.

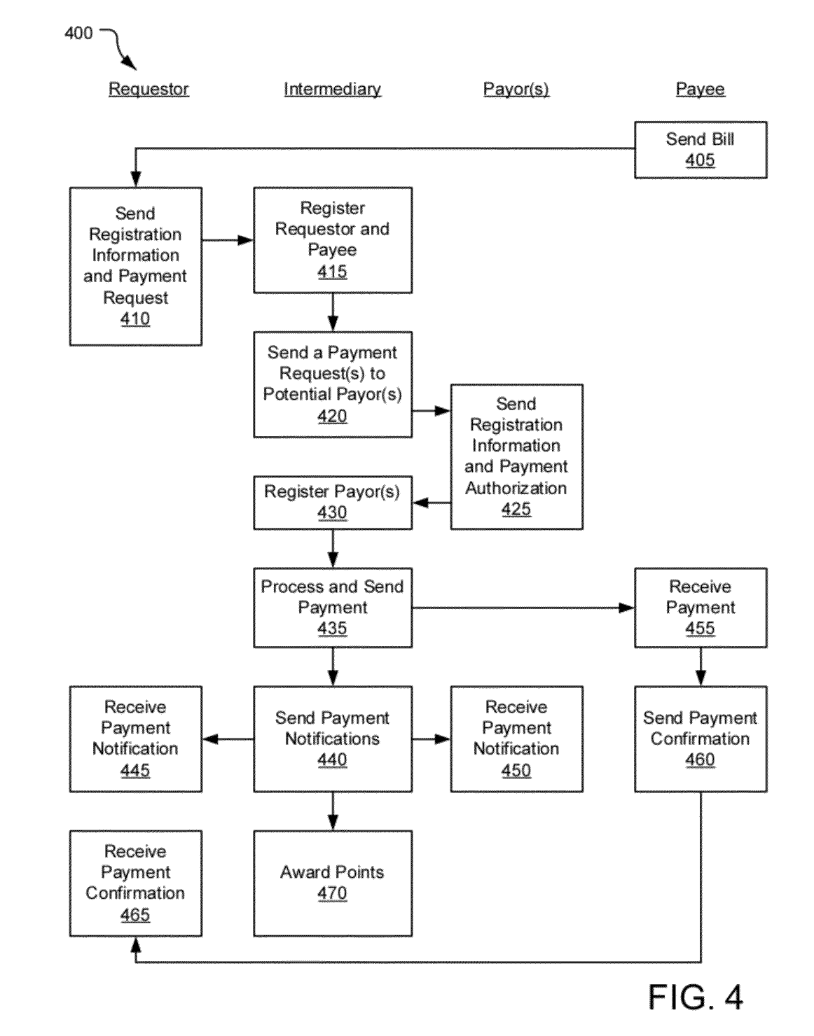

FIG. 4 illustrates example operations 400 for requesting and directing a payment to satisfy a Requestor's monetary obligation. The example operations 400 performed by a Requestor, an Intermediary, one or more Payor(s), and a Payee are organized in columns. The Payee sends the Requestor a bill for certain G&S (sending operation 405). The bill prompts the Requestor to pay the bill in order to receive or continue receiving the G&S. In implementations where the Requestor initiates payment to the Payee without prompting by the Payee, sending operation 405 is not performed. The bill may be receipt of any request for payment (e.g., a bill for G&S, a request for donations, a gift registry, etc.). The request for payment may be electronic.

The Requestor may be unable or unwilling to pay the entire bill. The Requestor may then send registration information and a payment request to the Intermediary (sending operation 410). The registration information may include, for example, the Requestor's name and contact information, the Payee's name and contact information, potential Payor names and contact information, the Requestor's social networks (e.g., Facebook® and Linkedln®), and broadcast channels (e.g., Twitter®). The registration information may further include a story or a personal video detailing why the Requestor is making a payment request.

The payment request may include a total requested amount (e.g., the total bill amount minus any the expected contribution for the Requestor), an individual requested amount (e.g., a maximum amount, a minimum amount, a range of amounts, or a specific amount requested from each potential Payor), instructions on how to send the payment requests to the potential Payors (e.g., utilize one or more of the Requestor's individual contacts, one or more of the Requestor's social media, one or more of the Requestor's broadcast media). For example, the Requestor may specify that the total bill is $100, $50 of which the Requestor wishes to receive from one or more Payor(s). The Requestor further specifies that the Requestor's individual contacts and Facebook friends are contacted with the payment request. The Requestor further specifies that between $1-$10 is requested from each contact until the entire requested amount (i.e., $50) is satisfied.

The Intermediary registers the Requestor and Payee based on the information collected from the Requestor (registering operation 415). In one implementation, the Intermediary stores the Requestor and Payee registrations on a web server accessible via personal computers, tablets, smartphones, and public access terminals, for example. According to the instructions including in sending operation 410, the Intermediary sends the potential Payors the payment request, including any story or video describing why the Requestor is making the payment request. In some implementations, the Requestor may directly send payment requests to potential Payors in lieu of or in addition to the payment requests sent by the Intermediary.

Payors that agree to contribute to payment of the Requestor's bill send registration information and payment authorization to the Intermediary (sending operation 425). The registration information may include, for example, the Payor's name and contact information and a message to the Requestor. The payment authorization may include, for example, an electronic credit or debit payment (e.g., credit card, Bank ACH, PayPal), a physical cash, check, or money order payment (if the Payor is at a public access terminal configured to accept physical payments), and payment instructions (e.g., whether payments are made anonymously or associated with the Payor). In some implementations, potential Payors that are unable or unwilling to contribute to payment of the Requestor's bill may forward the payment request to additional contacts (i.e., they become Forwarders). The Intermediary registers the responding Payors based on the information collected from each Payor (registering operation 430). In other implementations, the Requestor and/or Payors may register via a social networking media application associated with the Intermediary. Further, the Intermediary may authenticate registration or pull additional information regarding the Requestor and/or Payors from social networking media accounts associated with the Requestor and/or Payors.

The Intermediary processes and sends the collected payment from the Requestor and/or one or more Payors to the Payee (processing and sending operation 435) with instructions for the Payee to apply the payment to the Requestor's bill. In one implementation, the Intermediary sends payments to the Payee as it is collected from the Requestor and/or the one or more Payors until entire bill is paid. In another implementation, the Intermediary collects the payments submitted by the Requestor and/or one or more Payors until the total amount of the bill is collected. Once the total amount of the bill is collected, the Intermediary sends one payment to the Payee totaling the entire amount of the bill. The Intermediary may actually collect payment from the Requestor and/or the one or more Payors or merely collect payment authorizations from the Requestor and/or the one or more Payors, or some combination thereof. Further, the Intermediary may actually send payment to the Payee or merely send payment authorizations to the Payee, or some combination thereof. The Intermediary may also monitor the payments for compliance with governmental regulations regarding monetary contributions.

The Intermediary sends payment notifications to the Requestor and the Payor(s) (sending operation 440). The payment notifications may include, for example, a confirmation that a payment was made, the total amount of the payment, the individual contributions from the Requestor and/or the one or more Payors, and a date of the payment and/or individual contributions. The Requestor and the Payor(s) each receive the payment notification (receiving operations 445, 450).

The Payee receives the payment made by the Intermediary and applies the received payment to the Requestor's bill (receiving operation 455). The payment may be electronic. The Payee sends a payment receipt notification to the Requestor (sending operation 460). The payment receipt notification may include, for example, a confirmation that the payment was received, the total amount of the received payment, and a date of payment receipt. The Requestor receives the payment receipt notification (receiving operation 465). The payment notifications and payment receipt notifications may be sent via mail, e-mail, social media posting, and/or telephone message. In other implementations, the payment notifications and payment receipt notifications may be stored on the Intermediary's web server for access by the Requestor and/or the Payor(s) when they desire.

The Intermediary may award points to the Requestor, Payor(s), and/or Forwarders of the payment request according to a schema designed to encourage use of the Intermediary to pay bills (awarding operation 470) using a points module. The awarded points that Requestor, Payor(s), and/or Forwarders of the payment request accumulate can be used to send virtual gifts to other parties, as well as to gain notoriety within various social media and amongst other users of the Intermediary. For example, a Payor may receive points after making a successful payment applied toward the Requestor's bill. The Payor may then redeem the points to send virtual or real gifts to other registered users of the Intermediary or to encourage others to register as users of the Intermediary to retrieve their gift. A Forwarder of the payment request may receive a fraction of the points awarded to the Payor.

Further, the Requestor may receive points in exchange for sending a “thank-you” to Payors that contribute to payment of the Requestor's bill through the Intermediary. The Requestor may be blocked from making further payment requests until the “thank-you” is sent to all Payors that contribute to payment of the Requestor's bill through the Intermediary. Still further, the Intermediary may have a hierarchal system where registered users have levels or badges associated with the quantity of points they have been awarded. Awarded points and send/received gifts may be announced on registered user's social media pages or via other notifications. The registered users may monitor their points, levels/badges, and gifts received and sent via internet access to the Intermediary web server.

For example, a Payor is awarded 1 point for every $1 that he contributes to the Requestor's bill (i.e., 90 points are gained from contributing $90). The Payor is awarded 10% bonus points if the Payor is the contributor to complete a bill. The Payor is awarded 20% bonus points if the Payor is the contributor of the entire bill. The Payor gains an additional 5% bonus points for providing feedback on the Requestor. Forwarders of the payment request receive 1 karma point for every $3 successfully contributed to the Requestor's bill.

Requestors are awarded “requestor points.” The number of requestor points granted to the Requestor is equal to the number of dollars contributed by Payors. The Requester may be required to use all the requestor points before the Requestor can gain regular points and/or make another payment request. Requestor points are used to buy gifts for the Payors, as well as for other registered or non-registered individuals, which encourages interaction with the Intermediary. After all the Payors have been sent gifts, the Requester is free to use up the rest of the requestor points on gifts for others, in order to advertise the Intermediary. The gifts can be virtual (e.g., avatars, Facebook® gifts, digital cards, etc.) or physical (e.g., swag/promotional items). Requestors are granted 1 point for every 2 recipient points that are used. Buying Payors gifts within 24 hours of the Payor's contribution to the Requestor's bill nets the Requestor 10% bonus points. The Requester can also gain 5% bonus points by providing feedback to each of the Payors.

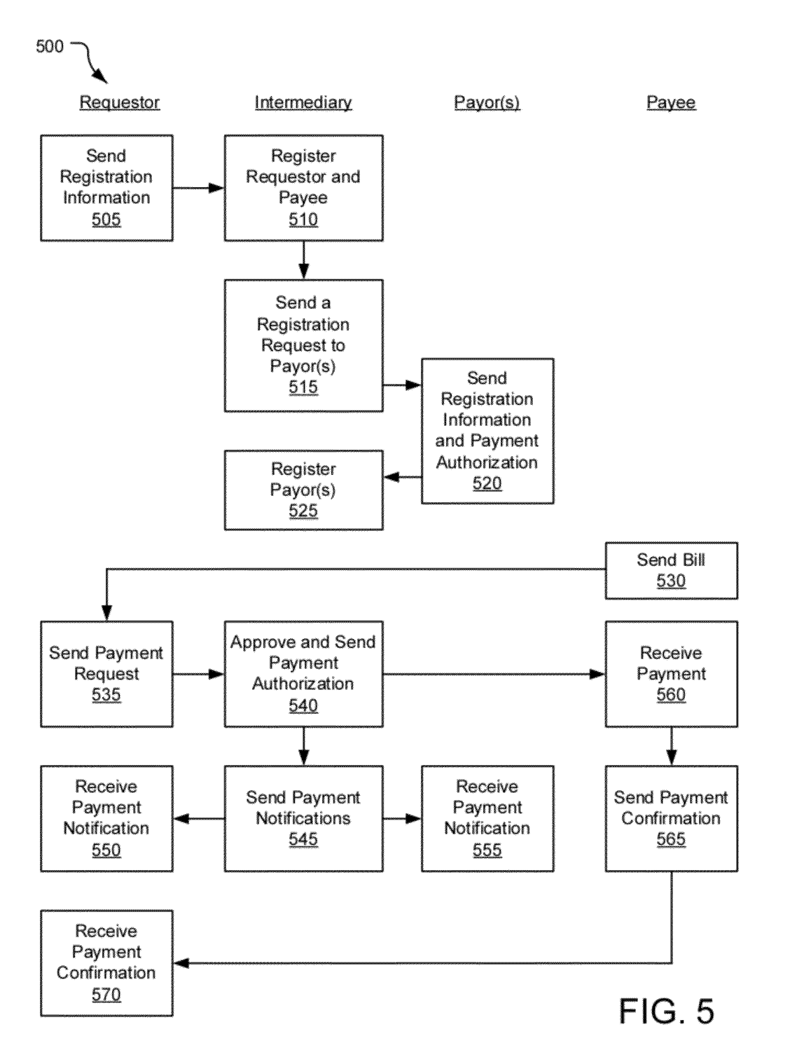

FIG. 5 illustrates example operations 500 for authorizing, requesting, and directing a payment to satisfy a Requestor's monetary obligation. The example operations 500 performed by a Requestor, an Intermediary, one or more Payor(s), and a Payee are organized in columns. The Requestor may wish to register one or more Payors that will assist the Requestor in meeting his/her financial obligations. For example, a grade school or college aged child may register as a Requestor and the child's parents may register as Payors. In a further example, an individual living in one country may register as a Requestor and the individual's spouse working in the same or a different country may register as a Payor. Other dependent or semi-dependent financial relationships may be registered.

The Requestor may send registration information to the Intermediary (sending operation 505). The registration information may include, for example, the Requestor's name and contact information, the Payee's name and contact information, and one or more Payor names and contact information. The Intermediary registers the Requestor and Payee based on the information collected from the Requestor (registering operation 510). In one implementation, the Intermediary stores the Requestor and Payee registrations on a web server accessible via personal computers tablets, smartphones, and public access terminals, for example.

The Intermediary sends the Payor(s) a registration request (sending operation 515). In some implementations, the Requestor may directly send registration requests to the Payor(s) in lieu of or in addition to the registration requests sent by the Intermediary. The Payors send registration information, payment conditions, and payment authorization to the Intermediary (sending operation 520). The registration information may include, for example, the Payor's name and contact information. The payment conditions may include, for example, a maximum cumulative amount that may be charged, a maximum individual amount that may be charged, Payee restrictions (e.g., specific Payees are approved or disapproved), geographic Payee restrictions, and Payor notification instructions. The payment authorization may include, for example, an electronic credit or debit payment or authorization, a physical cash, check, or money order payment (if the Payor is at a public access terminal configured to accept physical payments). Actual payments are collected by the Intermediary and stored for use by the Requestor. The Intermediary registers the Payor(s) based on the information collected from each Payor (registering operation 525).

The Payee sends the Requestor a bill for certain G&S (sending operation 530). The bill prompts the Requestor to pay the bill in order to receive or continued receiving the G&S. In implementations where the Requestor initiates payment to the Payee without prompting by the Payee, sending operation 530 is not performed. The bill may be receipt of any request for payment (e.g., a bill for G&S, a request for donations, a gift registry, etc.).

The Requestor may be unable or unwilling to pay the entire bill. The Requestor may then send a payment request to the Intermediary (sending operation 535). The payment request may include, for example, a total requested amount (e.g., the total bill amount minus any the expected contribution from the Requestor) and an explanation for the Payor(s). For example, the Requestor may specify that the total bill is $100, $50 of which the Requestor wishes to receive from the Payor(s). The Requestor further specifies that the bill is for the Requestor's school books.

The Intermediary approves and sends the collected payment from the Requestor and/or the Payor(s) to the Payee (approving and sending operation 540) with instructions for the Payee to apply the payment to the Requestor's bill. The approval of the payment request is dependent on the payment conditions specified by the Payor(s) in operation 520. If the payment request is not approved, no payment is made to the Payee or additional authorization is requested from the Payor(s). Further, if there are multiple Payors, the Intermediary tracks the contribution amount made by each Payor. In some implementations, the contribution amount for each Payor is specified in advance (e.g., when parent Payors share financial responsibility for the child Requestor at a specific proportion).

In one implementation, the Intermediary sends payments to the Payee as they are collected from the Requestor and/or the one or more Payors until entire bill is paid. In another implementation, the Intermediary collects the payments submitted by the Requestor and/or one or more Payors until the total amount of the bill is collected. Once the total amount of the bill is collected, the Intermediary sends one payment to the Payee totaling the entire amount of the bill. The Intermediary may actually collect payment from the Requestor and/or the one or more Payors or merely collect payment authorizations from the Requestor and/or the one or more Payors, or some combination thereof. Further, the Intermediary may actually send payment to the Payee or merely send payment authorizations to the Payee, or some combination thereof.

The Intermediary sends payment notifications to the Requestor and the Payor(s) (sending operation 545). The payment notifications may include, for example, a confirmation that a payment was made, the total amount of the payment, the individual contributions from the Requestor and/or the one or more Payors, and a date of the payment and/or individual contributions. The Requestor and the Payor(s) each receive the payment notification (receiving operations 550, 555).

The Payee receives the payment made by the Intermediary and applies the received payment to the Requestor's bill (receiving operation 560). The Payee sends a payment receipt notification to the Requestor (sending operation 565). The payment receipt notification may include, for example, a confirmation that the payment was received, the total amount of the received payment, and a date of payment receipt. The Requestor receives the payment receipt notification (receiving operation 570). The payment notifications and payment receipt notifications may be sent via mail, e-mail, and/or telephone message. In other implementations, the payment notifications and payment receipt notifications may be stored on the Intermediary's web server for access by the Requestor and/or the Payor(s) when they desire. Further, a points system as described in detail with regard to the operation 470 of FIG. 4 may be applied to operations 500 of FIG. 5.

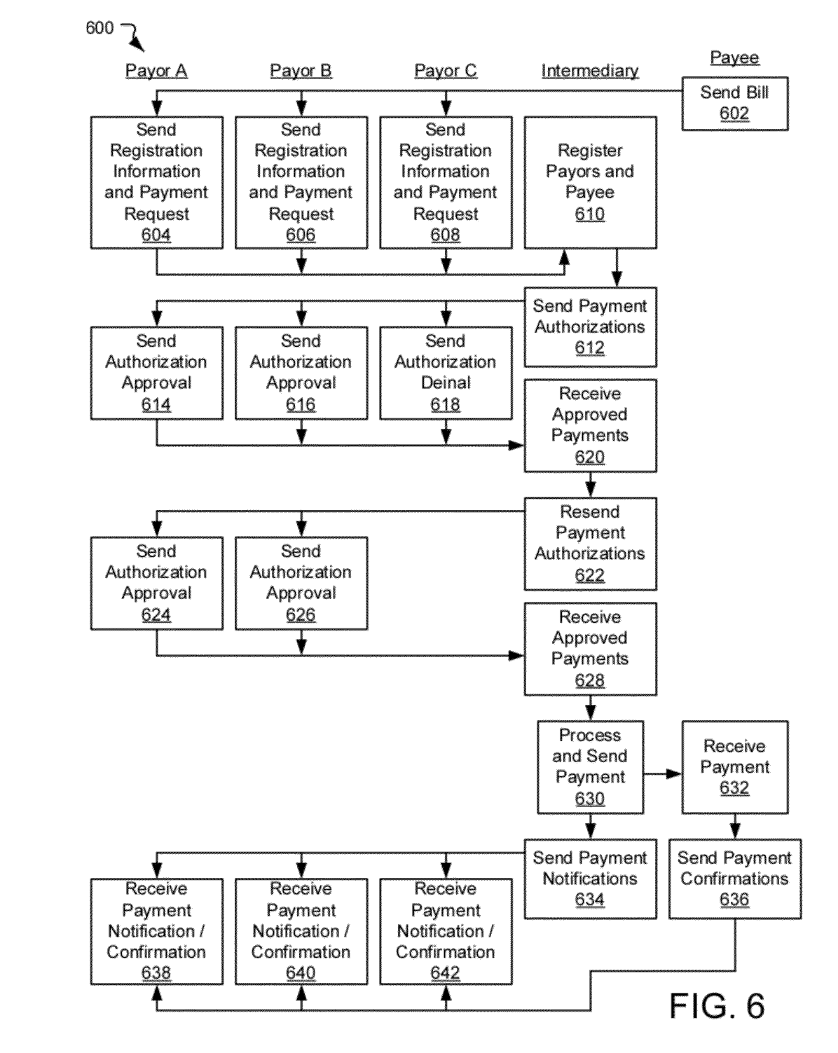

FIG. 6 illustrates example operations 600 for authorizing and directing multiple payments to satisfy a monetary obligation of multiple Payors. The example operations 600 performed by Payor A, Payor B, Payor C, an Intermediary, and a Payee are organized in columns. In some implementations, a group of Payors is responsible for payment of a bill. For example, roommates are often jointly responsible for rent, power, gas, cable, telephone, and water bills. Each roommate wishes that the bills be paid so that the flow of G&S continues, but none of the roommates are responsible for payment of the entire joint bill.

The Payee sends each of the Payors a bill for certain G&S (sending operation 602). The bill prompts the Payors to pay the bill in order to receive or continue receiving the G&S. In implementations where the Payors initiate payment to the Payee without prompting by the Payee, sending operation 602 is not performed. The bill may be receipt of any request for payment (e.g., a bill for G&S, a request for donations, a gift registry, etc.). The Payors may then send registration information and a payment request to the Intermediary (sending operations 604, 606, 608). The registration information may include, for example, the Payors'names and contact information, the Payee's name and contact information, and stored value or credit account access numbers associated with each of the Payors. The payment request may include a total bill amount, individual Payor contribution amounts, and a deadline for payment. Each Payor may also include an allowable overcharge (e.g., 25%) that they may be charged to compensate for other Payors that may be unable to pay. For example, the Payors may specify that the total bill is $100, $50 of which is to be paid by Payor A, $30 of which is to be paid by Payor B, and $20 of which is to be paid by Payor C.

The Intermediary registers the Payors and the Payee based on the information collected from the Payors (registering operation 610). In one implementation, the Intermediary stores the Payor and Payee registrations on a web server accessible via personal computers tablets, smartphones, and public access terminals, for example. According to the instructions including in sending operations 604, 606, 608, the Intermediary sends payment authorizations to the stored value or credit accounts associated with each of the Payors for the amounts indicated in the payment requests (sending operation 612). The stored value or credit accounts may be held with the Intermediary itself or a third party.

If sufficient funds are available in a credit or stored value account associated with a Payor, an authorization approval is sent from the Payor's account back to the Intermediary. If insufficient funds are available in a credit or stored value account associated with a Payor or the credit or stored value account associated with the Payor has been canceled or closed, an authorization denial is sent from the Payor's account back to the Intermediary. Accounts associated with Payor A and Payor B each send the Intermediary approvals to charge or withdraw the requested amount (sending operations 614, 616). An account associated with Payor C sends the Intermediary a denial to charge or withdraw the requested amount (sending operation 618).

The Intermediary receives the approved charges or withdraws to cover the Payors' bill (receiving operation 620). If the entire bill were covered, the Intermediary may process and send payment to the Payee (processing and sending operation 630). However, since the charge or withdrawal from the account associated with Payor C was denied, the entire amount of the bill has not been covered. The Intermediary may attempt to satisfy the bill by sending out additional authorization approvals to the Payors to collect the additional funds (resending operation 622). These additional authorizations may be approved if they do not exceed the overcharge limits placed on each of the accounts by the individual Payors. Accounts associated with Payor A and Payor B each send the Intermediary approvals to charge or withdraw the additional requested amount (sending operations 624, 626). The Intermediary receives the additional approved charges or withdraws to cover the Payors' bill (receiving operation 628). In addition, the Intermediary may attempt to charge or withdrawn a lesser amount from an account associated with Payor C to partially collect the amount due from Payor C.

For example, in order to pay the $100 bill, $50 is withdrawn from an account associated with Payor A, as previously agreed. Further, $30 is withdrawn from an account associated with Payor B, also as previously agreed. However, the $20 that should have been withdrawn from an account associated with Payor C has been denied. As a result, only $80 of $100 is collected from the Payor's accounts on the first authorization round. On a second authorization round, an additional $10 is withdrawn from accounts associated with each of Payor A and Payor B. As a result, the entire $100 is collected and the bill may be paid even though Payor C did not contribute. Further, lesser amounts may be attempted on payor C's account (e.g., $5 and $2) in order to partially satisfy Payor C's agreed upon contribution to paying the bill.

The Intermediary processes and sends the collected payments from the Payors to the Payee (processing and sending operation 630) with instructions for the Payee to apply the payment to the Payors' bill. In one implementation, the Intermediary sends payments to the Payee as they are collected from the Payors until entire bill is paid. In another implementation, the Intermediary collects the payments submitted by the Payors until the total amount of the bill is collected. Once the total amount of the bill is collected, the Intermediary sends one payment to the Payee totaling the entire amount of the bill. The Intermediary may actually collect payment from the Payors or merely collect payment authorizations from the Payors, or some combination thereof. Further, the Intermediary may actually send payment to the Payee or merely send payment authorizations to the Payee, or some combination thereof. The Payee receives the payment made by the Intermediary and applies the received payment to the Payors' bill (receiving operation 632).

The Intermediary sends payment notifications to each of the Payors (sending operation 634). The payment notifications may include, for example, a confirmation that a payment was made, the total amount of the payment, the individual contributions from each Payor, and a date of the payment and/or individual contributions. The Payee sends payment receipt notifications to each of the Payors (sending operation 636). The payment receipt notifications may include, for example, a confirmation that the payment was received, the total amount of the received payment, and a date of payment receipt.

The Payors each receive the payment notification and payment receipt notification (receiving operations 638, 640, 642). The payment notifications and payment receipt notifications may be send via mail, e-mail, and/or telephone message. In other implementations, the payment notifications and payment receipt notifications may be stored on the Intermediary's web server for access by the Requestor and/or the Payor(s) when they desire.

Further, the Intermediary may collect and store the data regarding the amount paid by each Payor. With recurring bills, the Payor may attempt to overcharge previously underpaying Payors in subsequent bills to make up for the previous undercharges. For example, during the next billing cycle, Payor C may be charged $20 ($10 for the current billing cycle and $10 for the previous billing cycle). Further, the Intermediary may send out notices to each of the Payors informing them of the underpayment by Payor C and requesting that Payor C submit additional payment to compensate Payors A and B for their additional contribution to the bill. Further, a points system as described in detail with regard to the operation 470 of FIG. 4 may be applied to operations 600 of FIG. 6.

The following is an example scenario for requesting and receiving payments via an Intermediary. A Facebook® user finds an application associated with the Intermediary on Facebook®, and decides to add it to his profile. The user authorizes the application, which registers the user with an Intermediary account using information from the user's Facebook® profile. Optionally, the user may access his account directly through the Intermediary and update any account details that are missing or different from the user's Facebook® account. The account details may include email address, billing details, etc., for example

The user makes a payment request via the Facebook® Intermediary application. The user inputs information about an outstanding bill (which may be linked online) and inputs the total bill amount (e.g., $50), due date of the bill, and whether he wants the bill to be public or private. The user may also input a story explaining the reason that the user does not have $50 available to pay this bill. The user may further attach a copy of the bill as proof of the outstanding amount.

The user chooses several of his Facebook® friends as recipients of the payment request. This selection may be accomplished through the Facebook® “Share” interface. After the payment request has been placed, the user receives notification that 2 of his Facebook® friends have paid $25 each, and that his bill has been paid. The user then receives 50 requestor points, which he uses to purchase a cat avatar item for one Facebook® friend and a dog avatar item for the other Facebook® friend. He ends up with 10 leftover requestor points, so he purchases a fish avatar item for a 3rd Facebook® friend that did not contribute to his bill. The user also views his Intermediary point level, and sees that he has gained 25 points, which moves him to level 2. He also has a new badge that is attached to his Intermediary account for other users to see.

The following is an example scenario for receiving a payment request and making a payment via an Intermediary. A user is checking her Facebook® notifications, and she realizes that a Facebook® friend of hers has sent a payment request. The user selects the payment request, reads the Requestor's story, and decides that she wants to help contribute to the Requestor's bill. The user selects a link associated with the Intermediary, and is brought to an account registration screen with the Intermediary. The user inputs some registration information (e.g., her name, email address, etc.), a payment type, account information (e.g., the user's PayPal account), and the amount of money she wants to contribute to the Requestor's bill (e.g., $25).

The user further receives notification that another Facebook® user has also paid $25 towards the Requestor's bill, and that the bill has been paid and completed. The user also receives a digital receipt to her email address for her records. The user views her points associated with the Intermediary, and sees that she has gained 50 points, enough to get her to level 3. She receives level 3 badge attached to her Intermediary account for other Intermediary users to see. Shortly after, the user also receives a thank you gift from the Requester, who sends her a cat avatar that she can add to her Intermediary account.

The following is an example scenario for forwarding a payment request through an Intermediary. A user receives a payment request via the Intermediary from a Facebook® friend. He reviews the information and realizes that he cannot help the Requestor with a financial contribution, but still wants to help the Requestor in another way. He forwards the payment request to some of his Facebook® friends, explains the forwarded payment request to his Facebook® friends, and encourages his Facebook® friends to contribute to payment of the Requestor's bill. The user later receives a Facebook® notification that one of his Facebook® friends has made a $50 contribution to the Requestor's bill. The user gains 17 points for the successful forward. The user also receives a fish avatar from the Requester in his Intermediary account.

The presently disclosed technology may be used as a contest-style application in partnership with a media company, retailer or billing company (i.e., a contest originator). The Intermediary contest application allows contest originators (acting as a Payors) to hold contests where the prize is the payment or forgiveness of a Requestor's bill. Users install a Facebook® application, where they can story explaining why they need help paying a bill. The contest originator chooses a winner and pays that Requestor's bill. This generates additional publicity for both the contest originator and the Intermediary.

If winners are selected on the basis of votes through social media sites, then the Requestors' vying to get their bills paid will be strongly motivated to tell their friends to vote. Votes could be “shared” on Facebook® so that friends of friends of Requestors will hear about the contest. The friends of friends could then submit their own bills and become Requestors themselves and thus continue the “viral” spread of the contest. Further, each voter may become registered with the Intermediary.

The following is an example scenario for running a contest-style application of the presently disclosed technology via an Intermediary. An organization or business (i.e., contest originator) creates a bill payment contest via the Intermediary. The contest originator may specify any specific rules, limitations and ending dates for that contest to the Intermediary. The contest may be standardized or customized for the specific contest originator. The contest can be partially embedded or referenced within the contest originator's Facebook® page. The contest may also be “skinned” to include the contest originator's colors and/or logo. The contest is then shared with the general public or a limited audience via the contest originator's Facebook® page and/or other advertising mechanisms.

If a user wishes to participate in the contest, he may add the Intermediary Facebook® application to his Facebook® account. Once the application has been added, the user is prompted to input what bill he needs paying, how much the bill is, and why the contest originator should help him pay it. Further, the user is signed up for an account with the Intermediary. The contest originator may allow the user to select whether he wishes to remain anonymous or not in regards to the contest publishing. The user can then share his payment request with other Facebook® friends and/or Twitter® followers. The notifications that Facebook® friends receive may be similar to that which the contest originator originally sent out, except that they are tailored to the Facebook® user who “shared” the contest.

The user is added to the contest and his payment request is sent back to the Intermediary and contest originator. Once the ending date of the contest has been reached, the contest is closed, and the contest originator selects a winner for the contest. Various selection mechanisms could be offered as options to the contest originator (e.g., most Facebook® votes, “best” story as judged by judges, closest bill to a secret number, and randomly). The winning user is sent a payment notification and e-mail indicating that she has won the contest, and steps to follow to complete the payment of his bill. The contest originator then shares to Facebook® and all users who are watching the contest see the results of the contest.

In one implementation, the winner of an Intermediary payment request contest may be determined based on a points system. For example, a Requestor may get 500 points if his story is interesting enough to be read on a radio station, 1 point for every unique view of the Requestor's video on YouTube®, 5 points for every unique commenter on YouTube®, 1000 points if the Requestor's video makes the YouTube® “Most Viewed” or “Popular” list, 10 points for every Twitter® re-tweet of the Requestor's story, 1500 points selectively allocated by celebrity or expert judges, and/or 5 points for every unique Facebook® user who views/reads The Requestor's story through Facebook®.

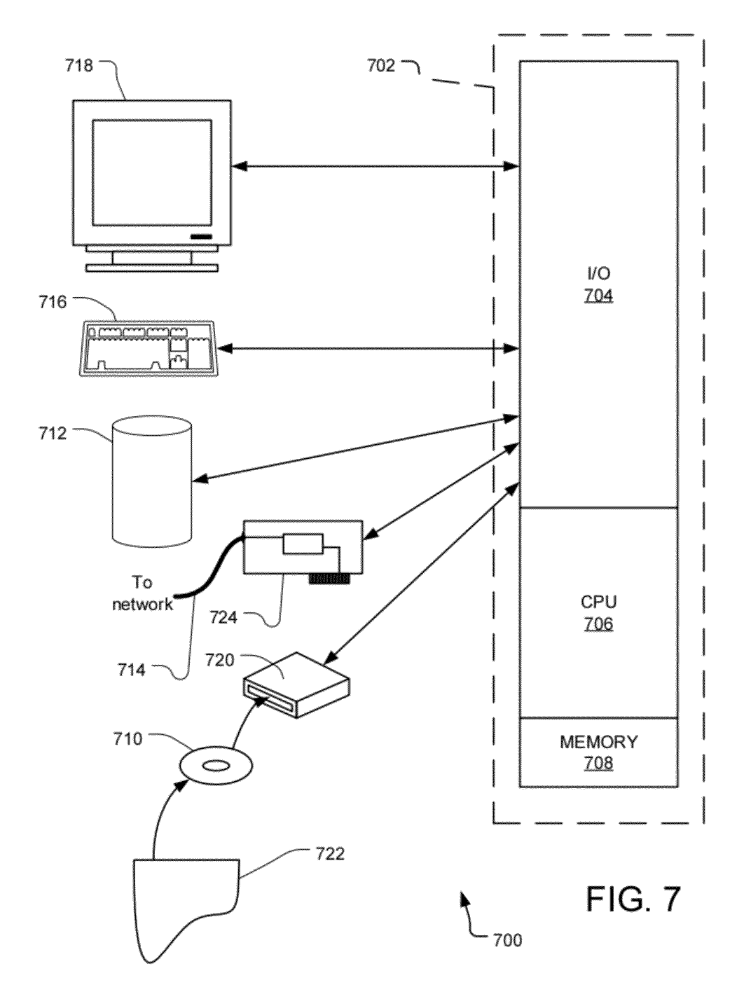

FIG. 7 illustrates an example computing system that can be used to implement the described technology. A general purpose computer system 700 is capable of executing a computer program product to execute a computer process. Data and program files may be input to the computer system 700, which reads the files and executes the programs therein. Some of the elements of a general purpose computer system 700 are shown in FIG. 7 wherein a processor 702 is shown having an input/output (I/O) section 704, a Central Processing Unit (CPU) 706, and a memory section 708. There may be one or more processors 702, such that the processor 702 of the computer system 700 comprises a single central-processing unit 706, or a plurality of processing units, commonly referred to as a parallel processing environment. The computer system 700 may be a conventional computer, a distributed computer, or any other type of computer. The described technology is optionally implemented in software devices loaded in memory 708, stored on a configured DVD/CD-ROM 710 or storage unit 712, and/or communicated via a wired or wireless network link 714 on a carrier signal, thereby transforming the computer system 700 in FIG. 7 to a special purpose machine for implementing the described operations.

The I/O section 704 is connected to one or more user-interface devices (e.g., a keyboard 716 and a display unit 718), a disk storage unit 712, and a disk drive unit 720. Generally, in contemporary systems, the disk drive unit 720 is a DVD/CD-ROM drive unit capable of reading the DVD/CD-ROM medium 710, which typically contains programs and data 722. Computer program products containing mechanisms to effectuate the systems and methods in accordance with the described technology may reside in the memory section 704, on a disk storage unit 712, or on the DVD/CD-ROM medium 710 of such a system 700. Alternatively, a disk drive unit 720 may be replaced or supplemented by a floppy drive unit, a tape drive unit, or other storage medium drive unit. The network adapter 724 is capable of connecting the computer system to a network via the network link 714, through which the computer system can receive instructions and data embodied in a carrier wave. Examples of such systems include Intel and PowerPC systems offered by Apple Computer, Inc., personal computers offered by Dell Corporation and by other manufacturers of Intel-compatible personal computers, AMD-based computing systems and other systems running a Windows-based, UNIX-based, or other operating system. It should be understood that computing systems may also embody devices such as Personal Digital Assistants (PDAs), mobile phones, gaming consoles, set top boxes, etc.

When used in a LAN-networking environment, the computer system 700 is connected (by wired connection or wirelessly) to a local network through the network interface or adapter 724, which is one type of communications device. When used in a WAN-networking environment, the computer system 700 typically includes a modem, a network adapter, or any other type of communications device for establishing communications over the wide area network. In a networked environment, program modules depicted relative to the computer system 700 or portions thereof, may be stored in a remote memory storage device. It is appreciated that the network connections shown are exemplary and other means of and communications devices for establishing a communications link between the computers may be used.

In an example implementation, the receiving module, sending module, and point module of the Intermediary are stored on the disk storage unit 712 and/or media within the a disk drive unit 720 and communicate with Requestor(s), Payor(s), Payee(s), etc. via wired or wireless network link 714. Processors 702 may execute one or more of the described functions of the Intermediary.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language. Further, not all logical operations may be preformed in all implementations, unless inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A method comprising:
receiving, at an intermediary, an electronic payment request associated with an identified transaction, the electronic payment request being received from a requesting party;
receiving, at the intermediary, an electronic payment authorization associated with the identified transaction, the electronic payment authorization being received from a payor; and
effecting an electronic payment associated with the identified transaction to a payee on behalf of the requesting party, in accordance with the payment authorization.

2. The method of claim 1, further comprising:
forwarding the electronic payment request from the intermediary to the payor, responsive to receiving the electronic payment request from the requesting party to the intermediary.

3. The method of claim 1 further comprising:
forwarding the electronic payment request from the intermediary to a group of potential payors, wherein multiple electronic payment authorizations are received from multiple individual payors within the group of potential payors.

4. The method of claim 3, wherein the electronic payment request is forwarded from the intermediary to the group of potential payors via one or more social networking media or broadcast media.

5. The method of claim 1, further comprising:
collecting, at the intermediary, registration information from the requesting party and the payor.

6. The method of claim 1, wherein the electronic payment authorization satisfies a financial obligation of the requesting party.

7. The method of claim 1, wherein receiving, at the intermediary, the electronic payment authorization from the payor is responsive to receiving, at the intermediary, the electronic payment request from the requesting party.

8. The method of claim 1, wherein the requesting party includes multiple individual requestors and the payor includes accounts associated with each of the multiple individual requestors.

9. The method of claim 8, further comprising:
requesting electronic payment authorizations from each of the accounts associated with each of the multiple individual requestors.

10. The method of claim 9, further comprising:
receiving electronic payment authorizations from each of the accounts associated with each of the multiple individual requestors.

11. The method of claim 9, further comprising:
receiving a denial of electronic payment authorization from an account associated with an individual requestor; and
requesting an additional electronic payment authorization from one or more of the accounts associated with each of the multiple individual requestors.

12. The method of claim 1, further comprising:
sending electronic payment notifications to one or both of the requesting party and the payor.

13. The method of claim 1, further comprising:
awarding points to the payor, responsive to receiving the electronic payment authorization from the payor.

14. An intermediary for facilitating payments on behalf of a requesting party, the intermediary comprising:
a receiving module that receives an electronic payment request associated with an identified transaction from a requesting party and an electronic payment authorization associated with the identified transaction from a payor; and
a sending module that effects a payment associated with the identified transaction to a payee on behalf of the requesting party, in accordance with the electronic payment authorization.

15. The intermediary of claim 14, wherein the sending module further forwards the electronic payment request to a group of potential payors, wherein multiple electronic payment authorizations are received from multiple individual payors within the group of potential payors.

16. The intermediary of claim 15, wherein the electronic payment request is forwarded to the group of potential payors via one or more social networking media or broadcast media.

17. The intermediary of claim 14, wherein the requesting party includes multiple individual requestors and the payor includes accounts associated with each of the multiple individual requestors.

18. The intermediary of claim 17, wherein the sending module further requests electronic payment authorizations from each of the accounts associated with each of the multiple individual requestors.

19. The intermediary of claim 17, wherein the receiving module further receives electronic payment authorizations from each of the accounts associated with each of the multiple individual requestors.

20. One or more computer-readable storage media encoding computer-executable instructions for executing on a computer system a computer process comprising:
receiving, at an intermediary, an payment request associated with an identified transaction, the payment request being received from a requesting party;
receiving, at the intermediary, an payment authorization associated with the identified transaction, the payment authorization being received from a payor; and
effecting an payment associated with the identified transaction to a payee on behalf of the requesting party, in accordance with the electronic payment authorization.

21. The computer-readable storage media of claim 20, wherein the computer process further comprises:
forwarding the payment request from the intermediary to the payor, responsive to receiving the payment request from the requesting party to the intermediary.

22. The computer-readable storage media of claim 20, wherein the computer process further comprises:
forwarding the payment request from the intermediary to a group of potential payors, wherein multiple payment authorizations are received from multiple individual payors within the group of potential payors.

23. The computer-readable storage media of claim 22, wherein the payment request is forwarded to the group of potential payors via one or more social networking media or broadcast media.

24. The computer-readable storage media of claim 20, wherein the computer process further comprises:
collecting, at the intermediary, registration information from the requesting party and the payor.

25. The computer-readable storage media of claim 20, wherein the payment authorization satisfies a financial obligation of the requesting party.

26. The computer-readable storage media of claim 20, wherein receiving, at the intermediary, the payment authorization from the payor is responsive to receiving, at the intermediary, the payment request from the requesting party.

27. The computer-readable storage media of claim 20, wherein the requesting party includes multiple individual requestors and the payor includes accounts associated with each of the multiple individual requestors.

28. The computer-readable storage media of claim 27, wherein the computer process further comprises:
requesting payment authorizations from each of the accounts associated with each of the multiple individual requestors.

29. The computer-readable storage media of claim 28, wherein the computer process further comprises:
receiving payment authorizations from each of the accounts associated with each of the multiple individual requestors.

30. The computer-readable storage media of claim 28, wherein the computer process further comprises:
receiving a denial of payment authorization from an account associated with an individual requestor; and
requesting an additional payment authorization from one or more of the accounts associated with each of the multiple individual requestors.

31. The computer-readable storage media of claim 20, wherein the computer process further comprises:
sending payment notifications to one or both of the requesting party and the payor.

32. The computer-readable storage media of claim 20, wherein the computer process further comprises:
awarding points to the payor, responsive to receiving the payment authorization from the payor.
